(19) United States
(12) Patent Application Publication
(10) Pub. No.: US 2022/0081169 A1
(43) Pub. Date: Mar. 17, 2022

(54) PRESS-FIT SPECIAL FORM CAPSULE

(71) Applicant: UT-BATTELLE, LLC, OAK RIDGE, TN (US)

(72) Inventors: Jeffrey B. Sharpe, Farragut, TN (US); Ryan P. Schultz, Knoxville, TN (US); Thomas R. Muth, Knoxville, TN (US)

(21) Appl. No.: 17/465,108

(22) Filed: Sep. 2, 2021

Related U.S. Application Data
(60) Provisional application No. 63/074,698, filed on Sep. 4, 2020.

(51) Int. Cl. B65D 39/00; G21C 19/02; B65B 7/28; B65D 51/16

(52) U.S. Cl. CPC B65D 39/0052; B65D 51/1661; B65B 7/2821; G21C 19/02

(57) ABSTRACT

A capsule for maintaining containment of a substance within a predetermined volume includes a housing having a tubular shape and walls with an inside surface. The housing has at least one open end. A cap is configured to be assembled coaxially to the housing. The cap includes a top and a plug configured to be inside the housing when the cap is assembled to the housing through the open end. An outer surface of the plug is dimensioned to engage an adjacent inside surface of the housing in an interference fit of the cap with the housing. A method for sealing a capsule is also disclosed.

### CROSS-REFERENCE TO RELATED APPLICATIONS

This application claims priority to U.S. 63/074,698 filed on Sep. 4, 2020, entitled “Press-Fit Special Form Capsule”, the entire disclosure of which incorporated herein by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in this invention.

### FIELD OF THE INVENTION

The present invention relates generally to capsules, and more particularly to special form capsules.

### BACKGROUND OF THE INVENTION

Special form capsules are containers for radioactive material particularly during transport, that must be sealable and leak proof. The capsules must also withstand the pressure and heat that can be generated in the capsule by radioactive decay. Additionally, such containers can only be opened by destroying the capsule, per 49 CFR 173.403.

A problem with current special form capsules is that some designs require welding to close and seal the container. A properly welded special form capsule offers an excellent seal with a very low leak rate and robust structural integrity. Welding is not an option in all circumstances that call for the use of special form capsules. The environments in which the capsule contents are sealed often preclude the use of welding for a variety of reasons. For example, the environment may contain flammable items which would be ignited by the welding arc. Welding equipment for these capsules can be significantly more expensive and bulkier than that for alternative methods of sealing. The welding equipment, its settings and related fixturing generally require more customization and more time to develop than alternative sealing methods. Welding equipment requires training and expertise to operate. The welding operation and subsequent finishing takes more time to complete than the alternative methods. The materials of the capsule also must be suitable for welding.

Attempts have been made to produce an alternative design of special form capsule that do not require welding. Some previous attempts at non-welded special form capsules rely on a threaded connection to apply pressure between two tapered surfaces. The resulting seal is steadily weakened with increasing pressure, and eventually releases some of the internal pressure and then reseals. It is not visually obvious afterward that this has occurred. The screw thread and tapered surfaces do not seal as consistently, and do not achieve as low a leak rate as some other designs.

A screw-loaded tapered plug seal has been provided for special form capsules. This capsule seals by means of a tapered (conical) plug which is pressed against a matching tapered cavity in the housing via a screw cap. The maximum amount of torque applied is limited to that which is sufficient to shear off the knob. The knob of the screw cap, which has flats, is turned with a wrench. The angle of the tapers of the plug and housing must match very closely to create a good seal. In practice, this is difficult and contributes to very inconsistent sealing performance. The friction in the screw threads can vary significantly, although the proper use of the capsule involves the use of a special grease to help mitigate this issue. The variance in the friction causes a corresponding variance in the force pressing the plug against the housing, contributing to inconsistent sealing performance. Once the plug is pushed into the housing, it is important for the screw cap not to back off the plug so adequate sealing pressure is maintained at the sealing surface. If the screw backs off, which has occurred during testing, sealing performance is reduced significantly or entirely. If the screw cap maintains its angular position while the housing experiences internal pressure (normally due to an increase in temperature), the plug is initially prevented from moving away from the sealing surface. However, as the internal pressure is increased, the plug and screw cap are compressed, while the housing is enlarged, eventually causing the interface pressure at the sealing surface to reduce to the point that the internal pressure bypasses the plug, and a leak occurs. In addition to that, once the capsule has relieved enough of its internal pressure, the housing, plug and screw cap relax toward their original volumes, thus resealing the capsule. It is possible for this capsule to leak out some of its contents, to reseal and not to have any visible signs of having failed on the outside. The sealing surface of the plug and housing, though reasonably large and tolerant of a small amount of debris, still constitute only one sealing interface. If the one interface fails, the whole capsule fails.

A screw-loaded metal o-ring seal has been provided for special form capsules. This capsule seals by means of a metal o-ring which is pressed against a mating surface in the housing via a screw cap. The maximum amount of torque applied is limited to that which is sufficient to shear off the knob on the cap, and the amount of compression of the o-ring is limited by a step in the cap. The knob of the screw cap is turned with a wrench. Although this design has been made to work, the sealing interfaces between the cap, housing and o-ring consist of very narrow regions of contact. Thus, the surfaces where that contact occurs are very sensitive to debris and surface defects. The required care with these surfaces is very difficult in some environments. Once the o-ring is compressed, it is important for the screw cap not to back off so adequate sealing pressure is maintained at the sealing surface. If the screw backs off, the sealing performance is reduced significantly or entirely. The sealing performance has shown signs of weakening during DOT regulatory testing, particularly after the drop test.

A key cap metal o-ring seal has been provided for special form capsules. This capsule seals by means of a metal o-ring which is pressed against a mating surface in the housing using a press to push the cap into position. Once the spring-loaded keys in the cap reach the locking grooves in the housing, they extend and thereby trap the cap in position with the o-ring in a compressed state. The sealing interfaces between the cap, housing and o-ring consist of very narrow regions of contact. Thus, the surfaces where the contact occurs are very sensitive to debris and surface defects. The required care with these surfaces is very difficult in some environments. This design has a significant number of parts and would be more expensive to make. Because this design relies on a metal o-ring for sealing, the sealing performance would likely weaken during DOT regulatory testing, particularly after the drop test.

### SUMMARY OF THE INVENTION

A capsule for maintaining containment of a substance within a predetermined volume includes a housing having a tubular shape and walls with an inside surface. The housing has at least one open end. A cap is configured to be assembled coaxially to the housing. The cap can include a top and a plug configured to be inside the housing when the cap is assembled to the housing through the open end. An outer surface of the plug is dimensioned to engage an adjacent inside surface of the housing in an interference fit of the cap with the housing.

The plug can include a first interference side portion and a first trough. The plug can further include a first interference protrusion. The first interference protrusion can have an outside diameter greater than the outside diameter of the first interference side portion. The first trough can be positioned between the first interference side portion and the first interference protrusion.

The capsule can further include a second interference side portion and a second trough. The plug can also include a second interference protrusion. The second interference protrusion can have an outside diameter greater than the outside diameter of the second interference side portion. The outside diameter of the second interference side portion can be greater than the outside diameter of the first interference side portion, and the outside diameter of the second interference protrusion can be greater than the outside diameter of the first interference protrusion.

The housing can include a plurality of inner interference surfaces comprising a plurality of inside diameters, and the inside diameters can decrease from the open end. The plug can include a relief. The relief has an outside diameter less than the outside diameter of the first trough and the second trough. The relief can be positioned between the first interference side portion and the second interference side portion to permit flexing of the plug.

The cap can include a flange configured to abut the open end of the housing when the cap is assembled to the housing. The plug can extend from the flange. At least a portion of the plug can have a tubular shape with an open interior. An outer surface of the plug can have a relief to enable flexing of the tubular portion of the plug. The plug in one embodiment can be solid.

The housing can include one of a first material and a second material, and the cap can include the other of the first material and the second material. The second material can have a higher yield strength than the first material. The yield strength of the first material can be at least 10% below the yield strength of the second material. The second material can have a higher thermal coefficient of thermal expansion than the first material. The coefficient of thermal expansion of the first material can be no more than 20% lower than the coefficient of thermal expansion of the second material. The coefficient of thermal expansion of the first material can be no more than 5% higher or lower than the coefficient of thermal expansion of the second material. A friction coefficient at an interface between the first and second materials at a first temperature can be equal to or greater than the coefficient of friction at a second temperature.

The first material can include austenitic-stainless steels, and the second material can include nickel-based super alloys. The first material can be annealed 304 stainless steel, and the second material can be annealed Nitronic 60. The first material can be Ta, and the second material can be Ti.

The capsule can be a special form capsule. The housing can include one or more a grooves disposed at its open end. The grooves are configured to vent, when the cap is assembled to the housing, gas trapped between the housing and the outer surface of the plug. The capsule maintains a vacuum seal.

In one embodiment, the plug has an end with an outer circumferential portion, and the housing comprises a ledge on the inner surface. The outer circumferential portion can be configured to engage the ledge with the plug is assembled into the housing.

A method for sealing a capsule includes the step of providing a housing having a tubular shape and walls with an inside surface. The housing has at least one open end. A cap is configured to be assembled coaxially to the housing. The cap includes a top and a plug configured to be inside the housing when the cap is assembled to the housing through the open end, wherein an outer surface of the plug is dimensioned to engage an adjacent inside surface of the housing in an interference fit of the cap with the housing. The cap is assembled to the housing by positioning the plug through the open end of the housing such that an outer surface of the plug engages an inside surface of the housing in an interference fit.

The plug can include a first interference side portion, a first trough, and a first interference protrusion. The first interference protrusion can have an outside diameter greater than the outside diameter of the first interference side portion. The method can include engaging the first interference side portion and the first interference protrusion to corresponding inside surfaces of the housing in interference fits, such that portions of the housing will be moved into the first trough.

The plug can further include a second interference side portion, a second trough, and a second interference protrusion. The second interference protrusion can have an outside diameter greater than the outside diameter of the second interference side portion. The outside diameter of the second interference side portion can be greater than the outside diameter of the first interference side portion, and the outside diameter of the second interference protrusion can be greater than the outside diameter of the first interference protrusion. The method can further include the step of engaging the second interference side portion and the second interference protrusion to corresponding inside surfaces of the housing in interference fits, such that portions of the housing will be moved into the second trough.

The cap can be engaged to the housing in a process in which one of the cap and the housing is taken to a temperature different to the other of the cap and the housing. The cap is assembled to the housing, and then the assembled cap and housing are taken to the same temperature, whereupon the cap will engage the housing in an interference fit.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a perspective view of a special form capsule.

FIG. 2 is an exploded perspective view.

FIG. 3 is a cross-section taken along line 3-3 in FIG. 1.

FIG. 4 is a side elevation of a cap.

FIG. 5 is a side elevation of a housing.

FIG. 6 is a cross-section taken along line 6-6 in FIG. 4.

FIG. 7 is a cross-section taken along line 7-7 in FIG. 2.

FIG. 8 is a side elevation of an assembled special form capsule.

FIG. 9 is a cross-section of an assembled special form capsule.

FIG. 10 is an enlarged cross-section of area 10 in FIG. 6.

FIG. 11 is a cross-section of a special form capsule in an initial stage of assembly.

FIG. 12 is an enlarged cross-section of area 12 in FIG. 11; FIG. 12A is an enlarged cross-section area 12A in FIG. 12; FIG. 12B is an enlarged cross-section of area 12B in FIG. 12.

FIG. 13 is an enlarged cross-section of area 12 in FIG. 11, in a second stage of assembly; FIG. 13A is an enlarged cross-section of area 13A in FIG. 13.

FIG. 14 is an enlarged cross-section of area 12 in FIG. 11, in a third stage of assembly; FIG. 14A is an enlarged cross-section of area 14A in FIG. 14; FIG. 14B is an enlarged cross-section area 14B in FIG. 14.

FIG. 15 is an enlarged cross-section of area 12 in FIG. 11, in a fourth stage of assembly; FIG. 15 A is an enlarged cross-section of area 15A in FIG. 15; FIG. 15B is an enlarged cross-section of area 15B in FIG. 15.

FIG. 16 is a cross-section of a special form capsule with a radioactive material contained therein, and in a first stage of operation.

FIG. 17 is a cross-section of a special form capsule with a radioactive material contained therein, in any second stage of operation.

FIG. 18 is a cross-section of area 18,19 in FIG. 17, and in an initial mode of operation.

FIG. 19 is a cross-section area 18,19 in FIG. 17, and in a subsequent mode of operation.

FIG. 20 is a cross-section of an alternative embodiment of a special form capsule.

FIG. 21 is an enlarged cross-section of area 21 in FIG. 20, in an initial mode of operation.

FIG. 22 is an enlarged cross-section of area 22 in FIG. 20, in a subsequent mode of operation.

### DETAILED DESCRIPTION OF THE INVENTION

A capsule for maintaining containment of a substance within a predetermined volume includes a housing having a tubular shape and walls with an inside surface. The housing has at least one open end. A cap is configured to be assembled coaxially to the housing. The cap includes a top and a plug configured to be inside the housing when the cap is assembled to the housing through the open end. An outer surface of the plug is dimensioned to engage an adjacent inside surface of the housing in an interference fit of the cap with the housing.

The plug can comprise structure which facilitates the interference fit. Such structure can include interference side portions which have diameters greater than corresponding diameters of the housing. Interference protrusions have diameters that are greater than the diameters of the interference side portions, but with a reduced height. One or more troughs can be provided which have diameters less than the diameters of the interference side portions and the interference protrusions. The troughs accept housing material which may bulge outward from the housing as the result of the strain created by the interference fit. The number, dimensions (diameter, width) and position on the plug of such features can vary.

There are two separate diameters in the housing that interfere with the cap. In each of these there are two regions of interference. The interference protrusion has a greater interference and is designed to exceed the yield strength of the housing to flow around the interference protrusion and create a better seal. The interference side portion has a lesser interference and is intended primarily to help secure the cap to the housing.

The cap can create additional sealing with sufficient internal pressure. The plug can include a relief. The plug can have a tubular region with a relief having a reduced diameter that allows for some flexing. The relief has an outside diameter less than the outside diameter of the troughs, the interference side portions and the interference protrusions. The relief can be positioned to permit flexing of the plug when the capsule is pressurized. The flexing enhances the interference fit, and the enhancement can be such that the force required to remove the cap is greater than the force required to press the cap into the housing and create the interference fit. Once the capsule is pressurized internally, and if there is sufficient pressure, this design feature generates additional sealing, or grip, to resist the internal pressure forcing out the cap because the region below the relief flares outward, pushing ever harder against the housing with increasing pressure. This pressure sealing effect works in a metal special form capsule to increase the capacity to hold internal pressure. The benefit provided by this feature is extra resistance to internal pressure above that provided by the interference fits. It is possible with this design feature to have a higher resistance (grip) to internal pressure than the force required to insert the cap initially.

Once the capsule is pressurized internally, and if there is sufficient pressure, this design generates additional sealing, or grip, to resist the internal pressure forcing out the cap because the region below the relief flares outward, pushing ever harder against the housing with increasing pressure. This pressure sealing effect works in a metal special form capsule to increase the capacity to hold internal pressure. It is possible with this design feature to have a higher resistance (grip) to internal pressure than the force required to insert the cap initially.

The plug can include a first interference side portion and a first trough. The plug can include a first interference protrusion. The first interference protrusion can have an outside diameter greater than the outside diameter of the first interference side portion. The first trough can be positioned between the first interference side portion and the first interference protrusion. The capsule can include a second interference side portion, a second trough, and a second interference protrusion. The second interference protrusion can have an outside diameter greater than the outside diameter of the second interference side portion. The outside diameter of the second interference side portion can be greater than the outside diameter of the first interference side portion, and the outside diameter of the second interference protrusion can be greater than the outside diameter of the first interference protrusion.

Each cap has four different surfaces that interfere with the housing. The benefit provided by this redundancy is that there are four points of failure before a leak occurs. The interference protrusions have a higher interference fit and a significantly smaller area than the other two. The interference protrusions are configured to create stresses in the housing that exceed the yield strength of its material but not in the cap. The benefit provided is that the housing material flows around the interference protrusions in the cap to enhance the seal already provided by the interferences.

The housing can include a plurality of inner interference surfaces comprising a plurality of inside diameters, and which correspond to the interference side portions and interference protrusions of the plug. The dimensions of the corresponding inside diameters of the housing in general can be less than the outside diameters of the corresponding interference side portions and interference protrusions, such that an interference fit is created when the plug is pressed into the housing. The inside diameters can decrease from the open end.

The cap can take various forms. The interior of the plug can be solid or hollow. At least a portion of the plug can have a tubular shape with an open interior. The top can span the open interior of the plug to provide a sealing cap construction. The cap can include a flange on the cap that is configured to abut the open end of the housing when the cap is assembled to the housing, the plug extending from the flange. The flange can participate in the formation of the seal.

The housing has a tubular shape with a hollow interior. The cross-section of the tubular shape can take different forms. The cross-section can be tubular, square or rectangular. Other shapes are possible. The dimensions of the housing in height and width can also vary.

The housing can be made of one of a first material and a second material. The cap can be made of the other of the first material and the second material. The second material can have a higher yield strength than the first material. The yield strength of the first material can be at least 10% below the yield strength of the second material. In one embodiment the cap is comprised of the second material and has a higher yield strength than does the material making up the housing.

One of the first material and the second material can have a higher thermal coefficient of thermal expansion than the other material. The coefficient of thermal expansion for the two materials must not differ enough, throughout the entire operating temperature range, to significantly reduce the designed interference of the sealing surfaces. For instance, in some implementations, the coefficient of thermal expansion of the first material can be no more than 20% lower than the coefficient of thermal expansion of the second material. The coefficient of thermal expansion of the first material can be no more than 5% higher or lower than the coefficient of thermal expansion of the second material.

The materials selected for the cap and housing are not only based on their yield strengths to accommodate the function of the interference protrusions, but consideration is also given to ensure that the coefficient of friction between the two materials increases (preferred) or at least does not diminish with increasing temperature. A friction coefficient at an interface between the first and second materials at a first temperature can be equal to or greater than the coefficient of friction at a second temperature. The benefit provided is that the grip of the seal joint is uncompromised due to increased temperature.

One of the first material and second material can include austenitic-stainless steels, and the other of the first material and the second material can include nickel-based super alloys. The first material can be annealed 304 stainless steel, and the second material can be annealed Nitronic 60. The first material can be Ta, and the second material can be Ti.

The capsule can be a special form capsule. The housing can include one or more laterally directed grooves disposed at its open end. The grooves are configured to vent, when the cap is assembled to the housing, gas trapped between the housing and the outer surface of the plug.

Because the capsule can contain magnitudes of pressure which far exceed that of vacuum, and because the capsule seal has a very low helium leak rate, the capsule can provide an effective vacuum seal throughout its entire operating range.

The plug can have an end with an outer circumferential portion, and the housing can include a ledge on the inner surface. The outer circumferential portion is configured to engage the ledge with the plug is assembled into the housing.

A method for sealing a capsule can include the step of providing a housing having a tubular shape and walls with an inside surface, wherein the housing has at least one open end. A cap configured to be assembled coaxially to the housing is provided. The cap includes a top and a plug configured to be inside the housing when the cap is assembled to the housing through the open end. An outer surface of the plug is dimensioned to engage an adjacent inside surface of the housing in an interference fit of the cap with the housing. The cap is assembled to the housing by positioning the plug through the open end of the housing such that an outer surface of the plug engages an inside surface of the housing in an interference fit.

The seal is accomplished by inserting the cap into the housing. This can be done by using a press to force the cap into the housing (press-fit) or by creating a sufficient temperature difference between the cap and housing to allow for insertion of the cap into the housing without a press (shrink-fit). This can also be accomplished by some combination of press and shrink fits, as long as the designed interferences are achieved.

The plug can include a first interference side portion, a first trough, and a first interference protrusion, the first interference protrusion having an outside diameter greater than the outside diameter of the first interference side portion. The method includes the step of engaging the first interference side portion and the first interference protrusion to corresponding inside surfaces of the housing in interference fits, such that portions of the housing will be moved into the first trough. The method can also include providing a plug which further includes a second interference side portion, a second trough, and a second interference protrusion. The second interference protrusion has an outside diameter greater than the outside diameter of the second interference side portion, and wherein the outside diameter of the second interference side portion is greater than the outside diameter of the first interference side portion, and the outside diameter of the second interference protrusion is greater than the outside diameter of the first interference protrusion. The method includes the step of engaging the second interference side portion and the second interference protrusion to corresponding inside surfaces of the housing in interference fits, such that portions of the housing will be moved into the second trough.

The interference fits and the lower region of the cap also provide superior resistance to internally-generated pressure in the capsule. Further, pressing capsules together requires less equipment and training than welding them. The interference-fit capsule sealing does not weaken with increasing internal pressure, but rather it fails suddenly, and the cap moves relative to the housing to give a visual indication of failure.

Additionally, the housing has vent grooves to eliminate false positives during leak testing. The vent grooves can be at the top of the housing. These vent any small volume of gas that gets trapped above the interferences between the housing and cap during insertion. The benefit provided is the possibility of false positives during leak testing is eliminated.

Testing was performed which included all three of the relevant DOT regulatory tests (impact, percussive and heat) for each capsule. The helium leak rate for capsules was <1E⁻⁸ Atm-cc/s, which is substantially less than the requirement of <2E⁻⁸ Atm-cc/s. Hydrostatic testing resulted in excellent retention of internal pressure, substantially exceeding predictions. This is an indication that the self-energizing pressure seal works as intended. Initially, the capsule is sealed by means of several interferences between the cap and housing. Interference fits (press or shrink) enable achievement of low rates of leakage (<1E⁻⁴ Atm-cc/s) with interference fits in special form capsules. In four tested capsules, the leak rates were all <2E⁻⁸ Atm-cc/s, even after all three DOT regulatory tests (impact, percussive and heat) were performed on each capsule. It should be noted that air can be expected to leak at a lower rate than helium.

Sealing the capsule requires that the cap be pressed into the housing with a press or else assembled as a shrink fit. The press can be a standardized press or one that is specially manufactured for this purpose. Opening the capsule is expected to occur by sawing through the housing at the indicator groove. The term “special form capsule” (SFC) dictates that opening the capsule must have obvious changes (damage) to the capsule afterward.

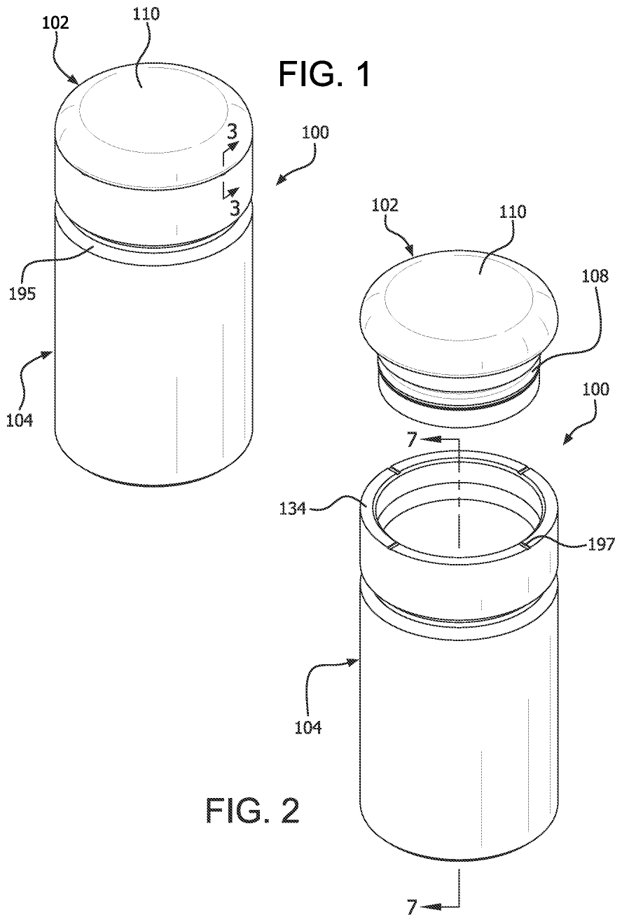

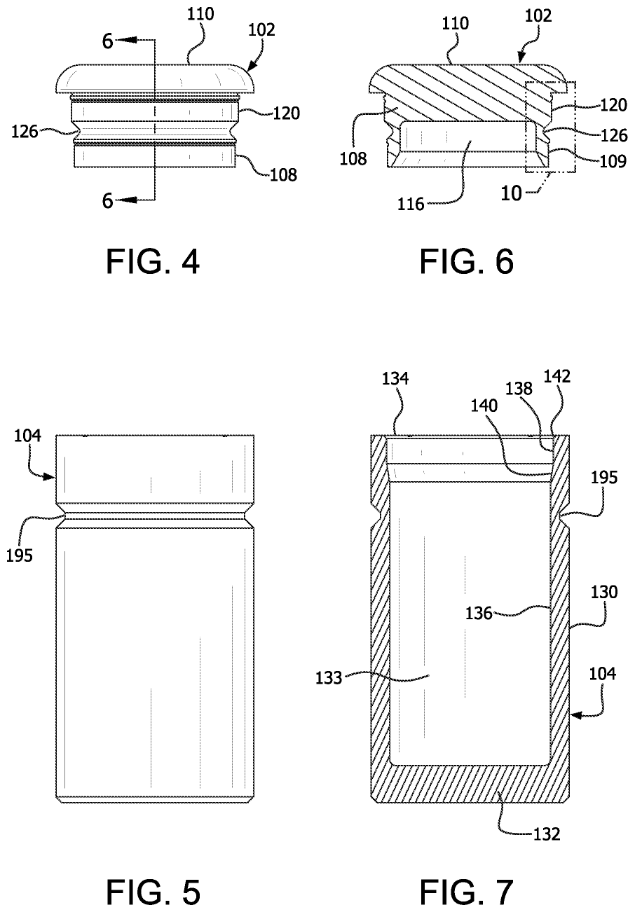

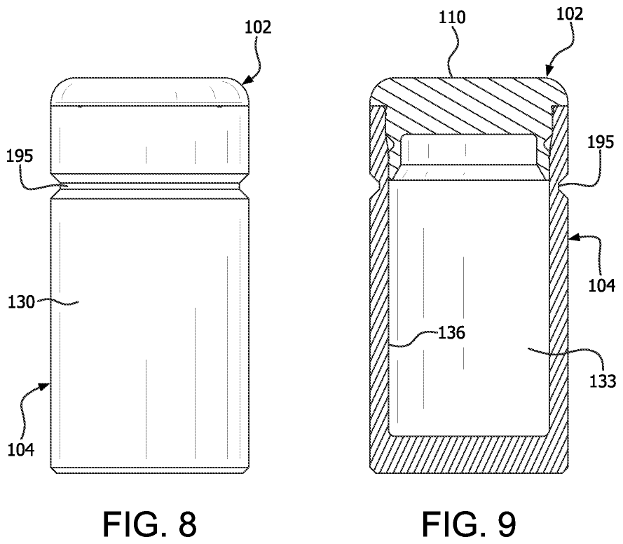

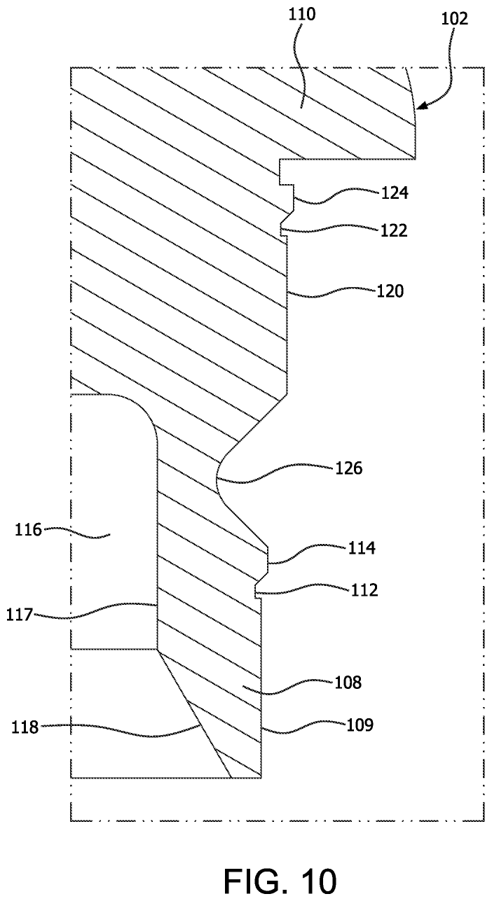

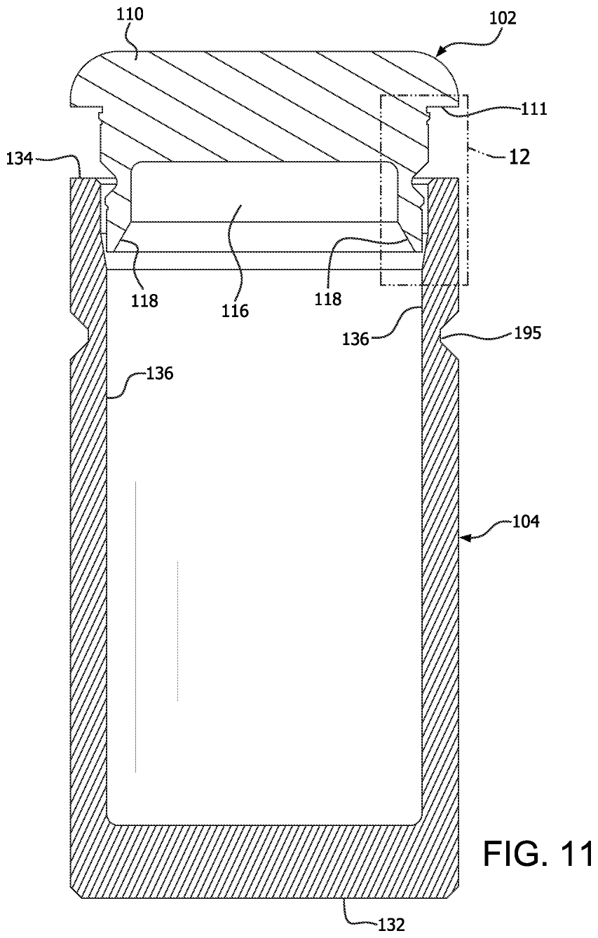

There is shown in FIGS. 1-10 a special form capsule 100 according to the invention. The capsule 100 includes a cap 102 and a housing 104. The cap 102 includes a top 110 and a depending plug 108. The cap 102 includes structure for engaging the housing 104 in an interference fit. This structure includes a first interference side portion 109. In some instances, the cap 102 can be sealed to the housing 104 by a single interference fit, such as the side portion 109 to a corresponding portion of the housing 104. Additional structure can be provided in other embodiments to form a more robust seal. A first trough 112 is adjacent the first interference side portion 109. The first trough 112 has an outside diameter that is less than the outside diameter of the first interference side portion 109. A first interference protrusion 114 is adjacent the first trough 112. The first interference protrusion 114 has an outside diameter that is greater than the outside diameter of the first interference side portion 109. The plug 108 can be solid or hollow, for example with an open interior 116 (FIG. 10). The open interior 116 can be defined in part by interior wall surface 117. A beveled surface 118 can be provided and slants downwardly and laterally outwardly.

The plug 108 can also include a second interference side portion 120. The second interference side portion 120 has an outside diameter that is greater than the outside diameter of the first interference side portion 109. The plug 108 can also include a second trough 122 adjacent the second interference side portion 120. The second trough 122 has an outside diameter that is less than the outside diameter of the second interference side portion 120. A second interference protrusion 124 can also be provided. The second interference protrusion 124 as an outside diameter that is greater than the outside diameter of the second interference side portion 120, and also greater than the outside diameter of the first interference protrusion 114.

The cap 102 can further include a relief 126. The relief 126 permits the flexing of the plug 108 under internal pressure within the capsule to further engage the housing in the interference fit. The relief 126 permits the first interference side portion 109 below the relief 126 to flex laterally outward.

The housing 104 is generally tubular and includes tubular side wall 130 and base 132 defining an open interior 133 with a first interference wall surface 136. Housing 104 has an open end 134. The cap 102 can further comprise a flange 111 for abutting and engaging the open end 134 of the housing 104. Adjacent the open end 134, the first interference wall surface 136 is dimensioned to engage portions of the plug 108 in an interference fit. The interference fit is shown in various stages in FIGS. 11-19.

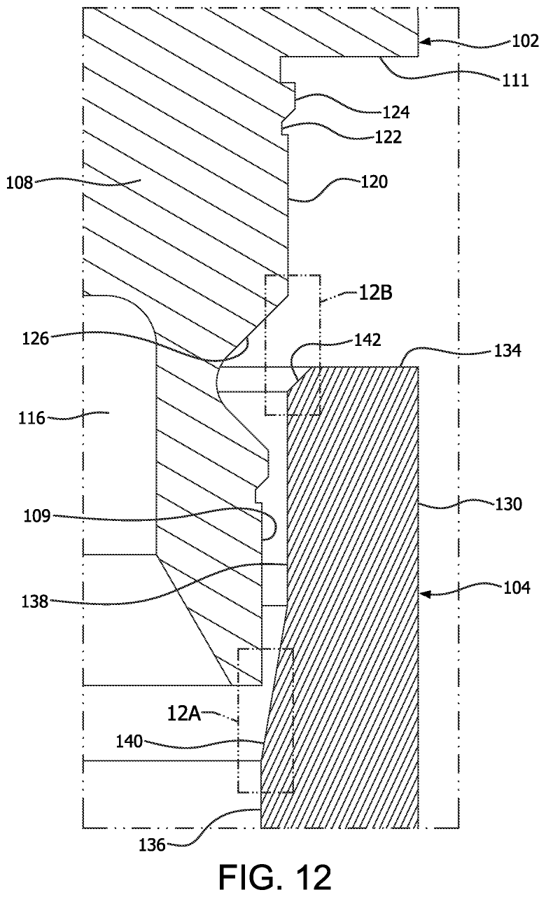

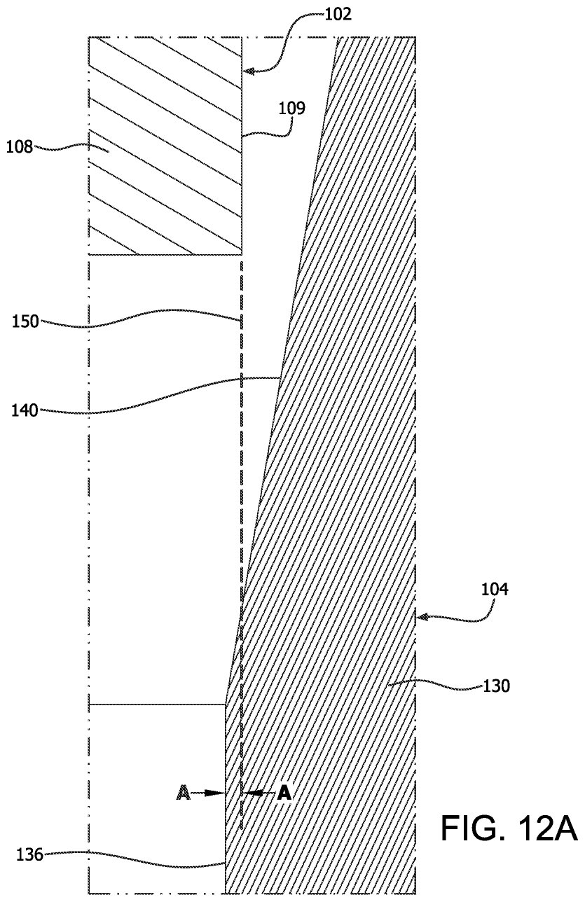

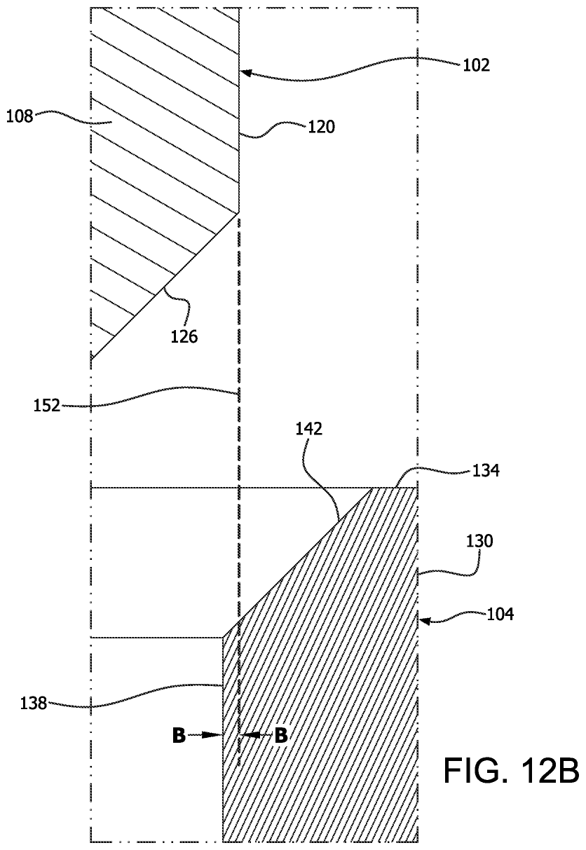

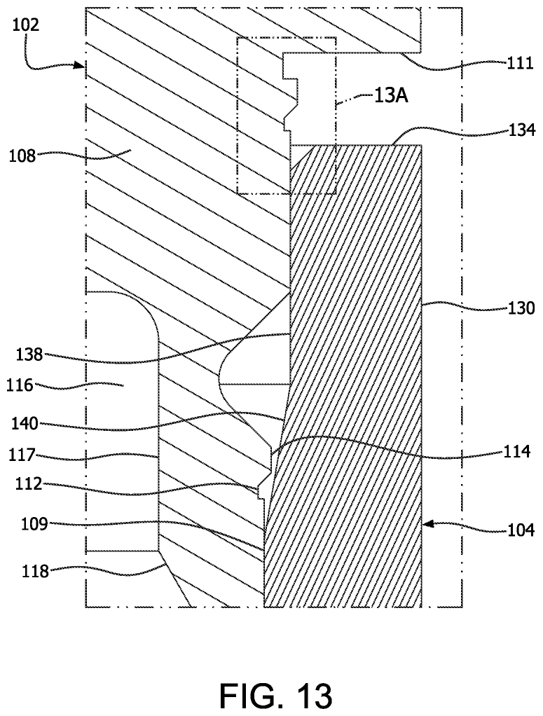

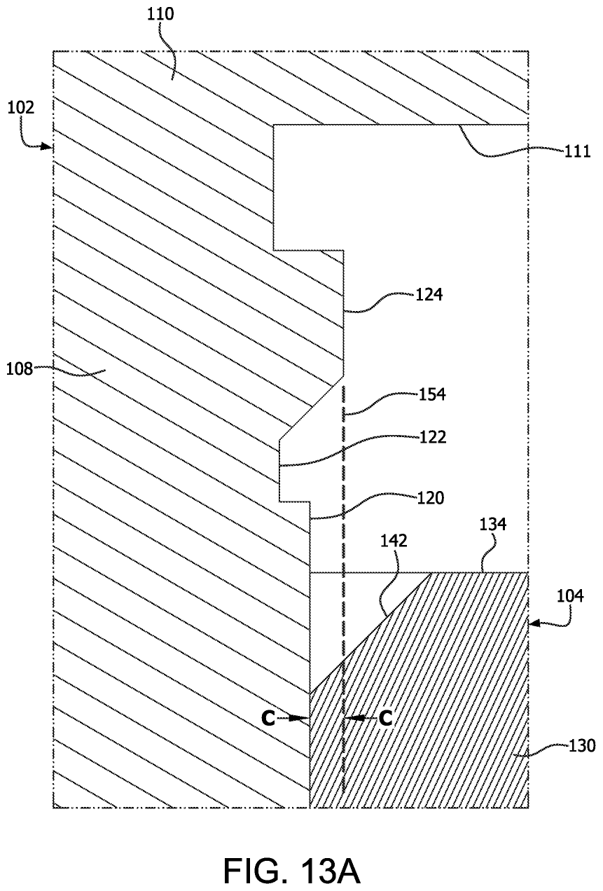

As shown in FIGS. 11, 12 and 12A-B, the cap 102 is initially positioned through the open end 134 of the housing 104. The diameter of the outside surface of the interference side portion 109 of the cap 102 as shown by dashed line 150 is greater than the diameter of a corresponding portion of the first interference wall surface 136, as shown by distance A-A in FIG. 12A. This distance will define one of the interference fits as the cap 102 is pressed into the housing 104. Similarly, the outside diameter of the second interference side portion 120 as shown by dashed line 152 is greater than the inside diameter of a second interference wall surface 138 of the housing 104, as shown by arrows B-B in FIG. 12B. This will define the interference fit between the interference side portion 120 and the corresponding second interference inside wall surface 138 of the housing wall 130. The diameter of the second interference wall surface 138 is greater than the diameter of the first interference wall surface 136. A beveled surface 140 transitions the second interference wall surface 138 to the first interference wall surface 136. The beveled surface 140 will engage the end of the plug 108 to transition the end of plug 108 to the second interference wall surface 136.

As shown in FIG. 13, as the cap 102 is pressed further into the housing 104 the first interference side portion 109 engages with the first interference wall surface 136 in an interference fit. The beveled surface 140 transitions from the first interference wall surface 136 to the second interference wall surface 138. As shown in FIG. 13A, the second interference protrusion 124 has an outside diameter as represented by dashed line 154 that is greater than the inside diameter of the second inside wall surface 138 of the housing wall 130 as shown by distance C-C. This difference will result in the interference fit.

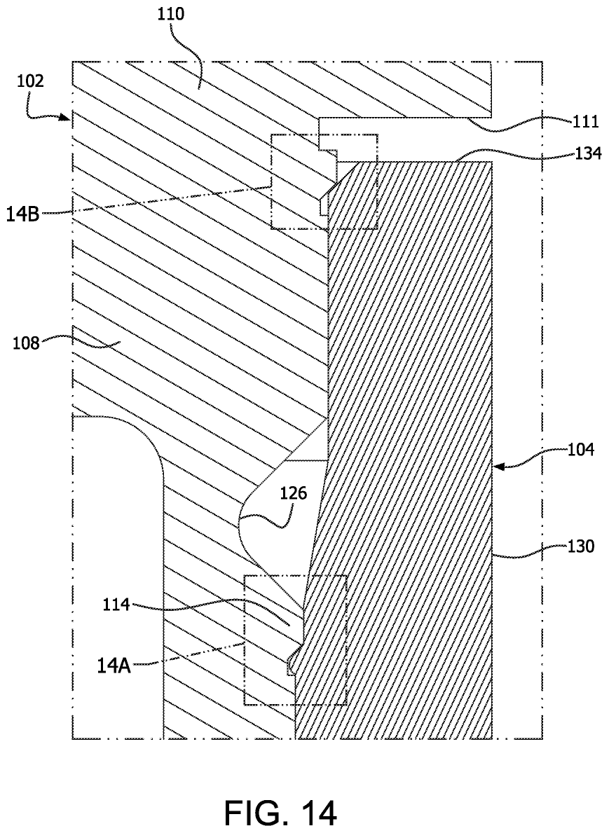

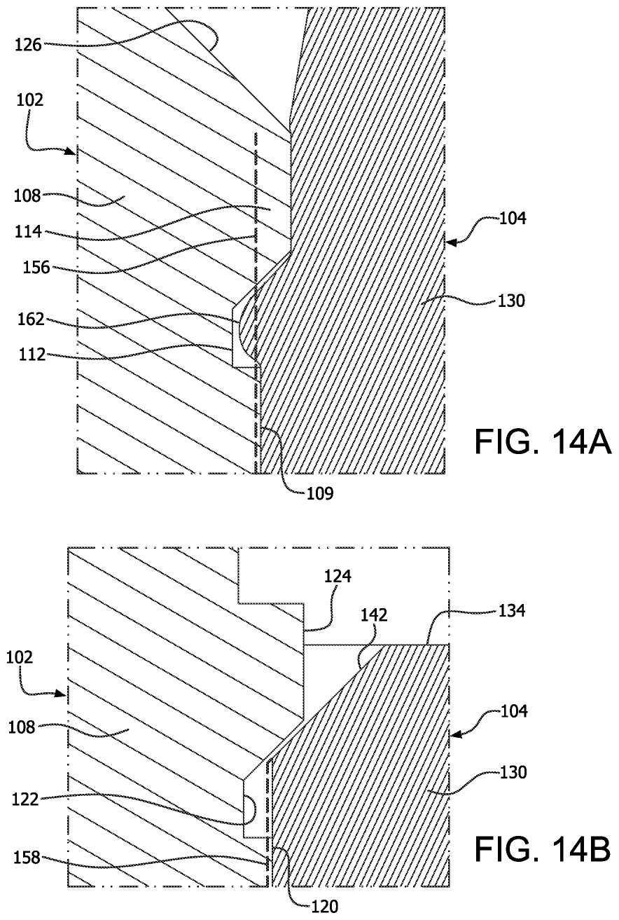

As the cap 102 is pressed further into the housing 104, the first interference protrusion 114 will engage the first interference wall surface 136 of the housing wall 130 (FIG. 14A). This is shown by dashed line 156 which represents the prior position of the first interference wall surface 136. As can be seen from FIG. 14A, the first interference side portion 109 has pushed the first interference wall surface 136 of the wall 130 a short distance, and the first interference protrusion 114 has pushed the first interference wall surface 136 a greater distance owing to the greater outside diameter of the first interference protrusion 114. This will cause stress in the material making up the housing wall 130 and this material will strain and create an accumulation of housing wall material 162 in the first trough 112. As shown in FIG. 14B, the second interference side portion 120 engages the second interference wall surface 138 the housing wall 130 in an interference fit, as indicated by dashed line 158 which represents the prior position of the second interference wall surface 138. A bevel 142 on the side wall 130 of the housing 104 to facilitate the pressing of the plug 108 and particularly the second interference protrusion 124 into the housing 104 and engagement of the interference fit.

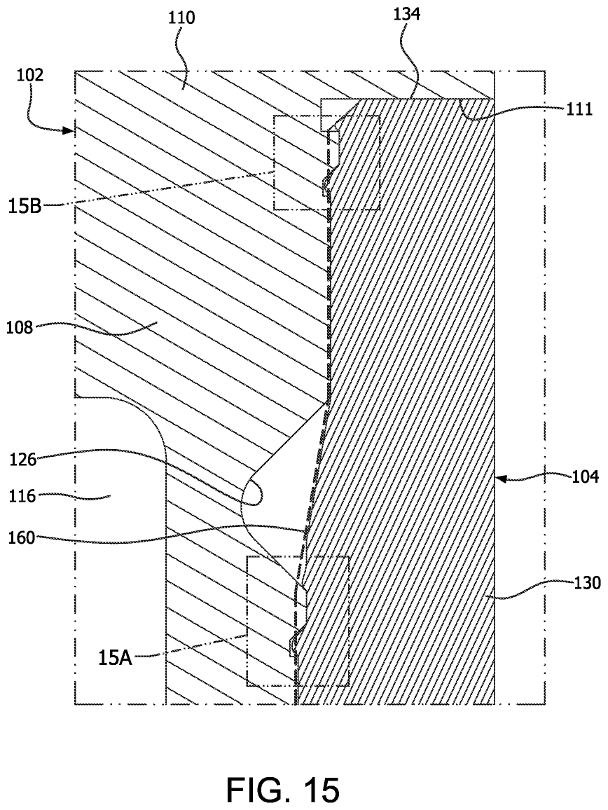

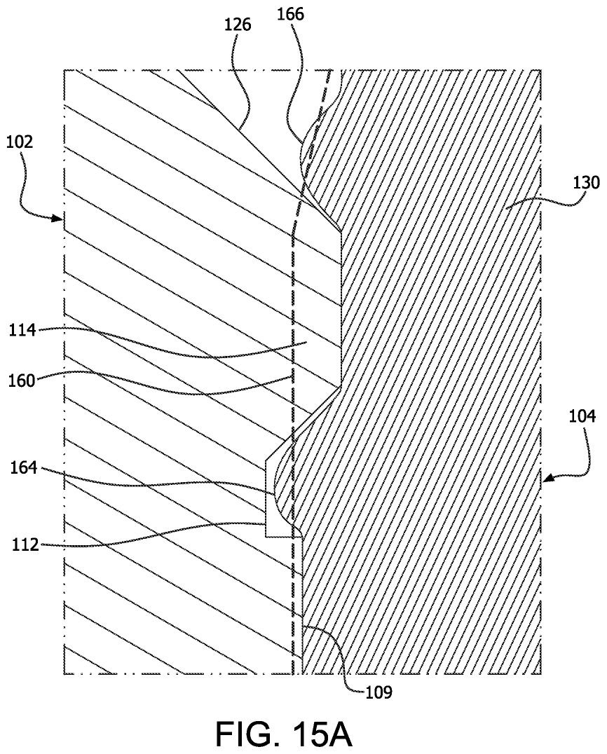

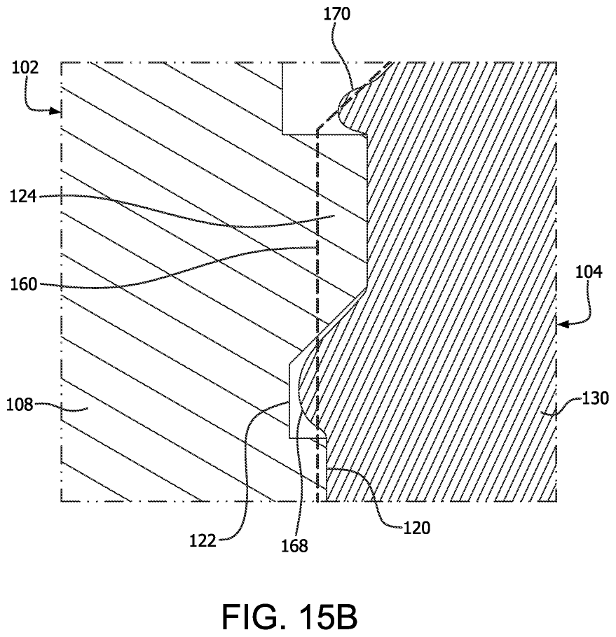

As the cap 102 is pressed still further into the housing 104, the second interference protrusion 124 will engage the bevel 142 and ultimately will be pressed into the second interference wall surface 138 as shown in FIG. 15. The first interference protrusion 114 will continue to move into the housing 104 and generate a strained portion 164 of material in the first trough 112 (FIG. 15A). As indicated by dashed line 160 indicating the prior position of the inside surfaces of the housing wall 130. A portion 164 of the housing wall 130 will accumulate in the first trough 112, and a portion 166 will accumulate in the relief 126. Also, a portion 168 will accumulate in the second trough 122. A small portion 170 of the wall material will accumulate above the second trough 124, filling the space between the bevel 142 and the flange 111 of the cap 102. The wall material that accumulates in the first trough 112, the second trough 122, and adjacent the beveled surface 142 will act as a seal against the escape of material from the capsule 100, in the manner of o-ring seals.

The number of interference side portions and corresponding interference wall surfaces can vary. Also, although the second interference wall surface 138 is shown as having a greater diameter than the first interference wall surface 136 of the housing wall 130, it is possible to have only a single interference wall surface diameter that engages with multiple interference side portions and interference protrusions.

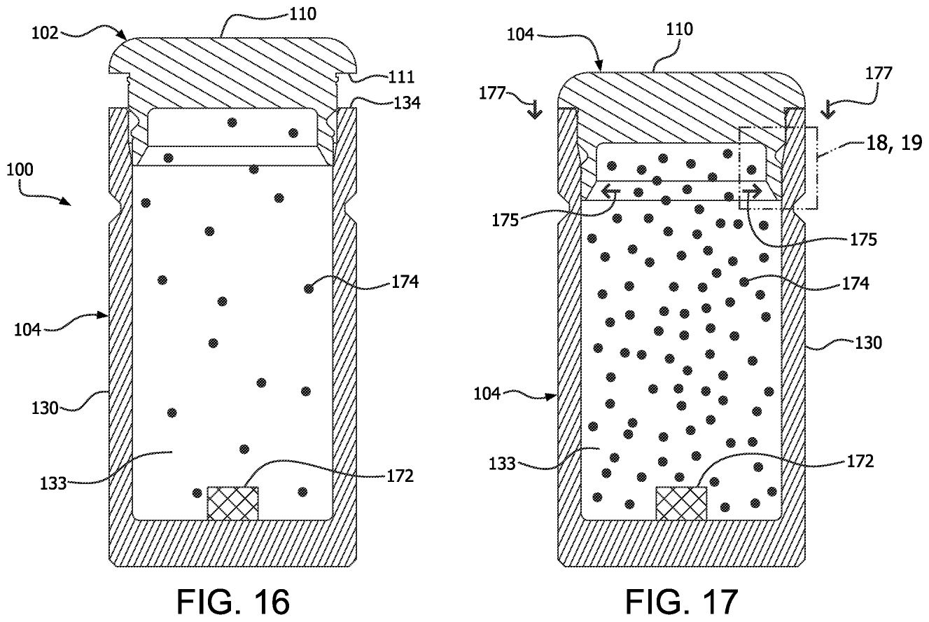

There is shown in FIGS. 16-19 the capsule 100 with a radioactive material 172 sealed within the capsule 100. Gas particles 174 can either be generated from the material 172 or can be gases trapped within the capsule. As shown in FIG. 17, the cap 102 is forced downward as shown by arrows 177 to create an interference fit between the cap 102 and the housing 104. The radioactive material 172 heats the trapped gas particles 174 thereby creating an elevated pressure within the open interior 133 of the housing 104 of the capsule 100. This internal pressure creates internal forces acting on the plug 108 away as shown by arrows 175.

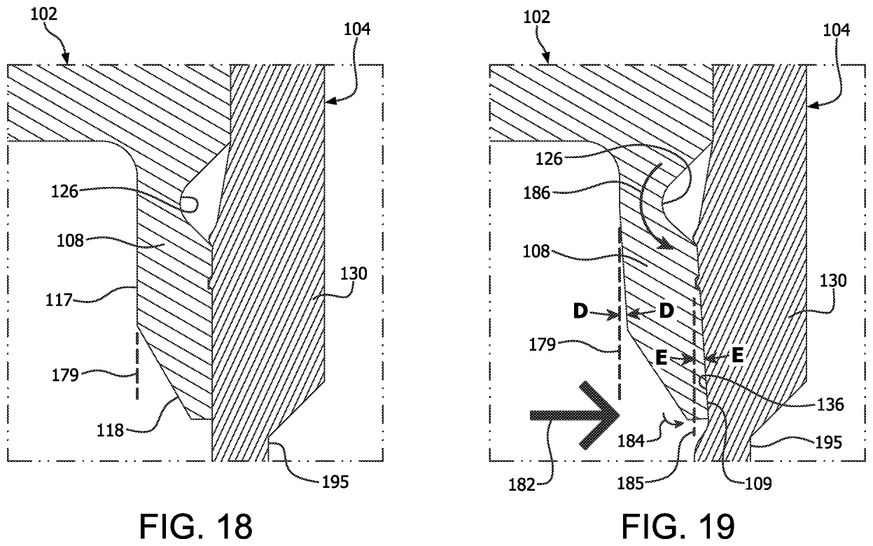

As shown in FIG. 18, the initial position of the inside surface 117 of the plug 108 is shown by dashed line 179. As the internal gas pressure builds within the capsule 100, a force shown by arrow 182 pushes outwardly against the inside surface 117 of the plug wall 108 and also the beveled surface 118. The relief 126 permits the plug wall 108 to bend outwardly as shown by arrow 186. This will press the plug wall 108 laterally outward, and particularly the interference side portion 109 will be pressed more tightly against the first inside wall surface 136 of the wall 130. The inside surface 117 of the plug 108 will be moved to a distance shown by arrows D-D, and the first interference side portion 109 will move from the initial position shown by dashed line 185 to a distance shown by arrows E-E. This creates a self-locking effect wherein pressure within the capsule 100 creates an even tighter seal between the cap 102 and the housing 104.

The seal created by the invention will be very tight and it will be difficult to remove the cap 102 from the housing 104. A groove or depression 195 can be provided to facilitate the cutting open of the sealed capsule 100. A special form capsule should show evidence of tampering or opening. The breaking of the capsule at the groove 195 will be evidence of such tampering.

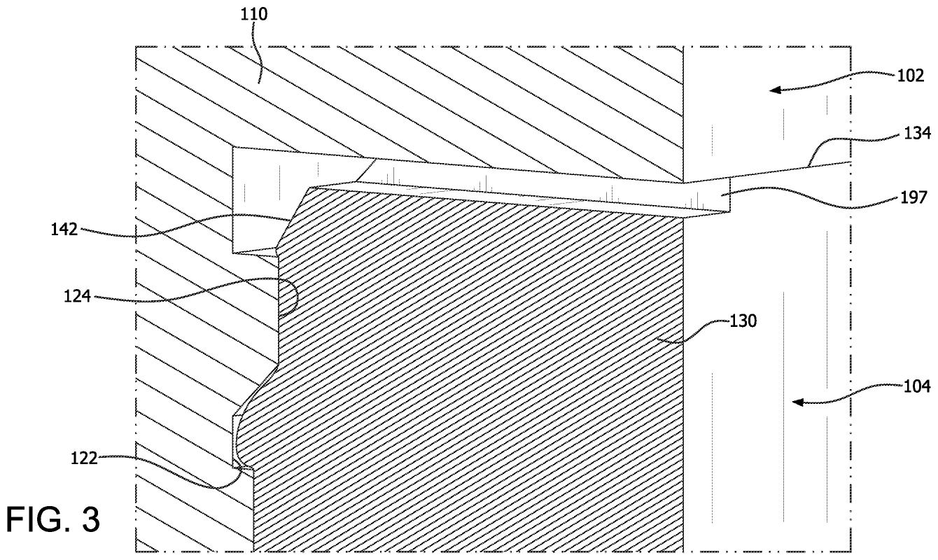

During assembly, gases will sometimes be trapped between the cap 102 and the housing 104 outside the intended sealing surface such as in the space above the second interference protrusion 124. Vents 197 (FIGS. 2-3) can be provided at the open end 134 of the housing 104. The vents 197 will provide a space between the flange 111 and the open end 134 for such gases to escape.

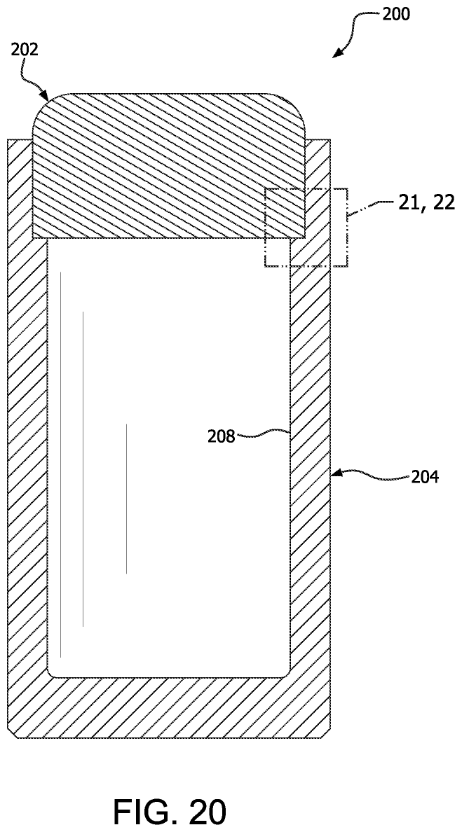

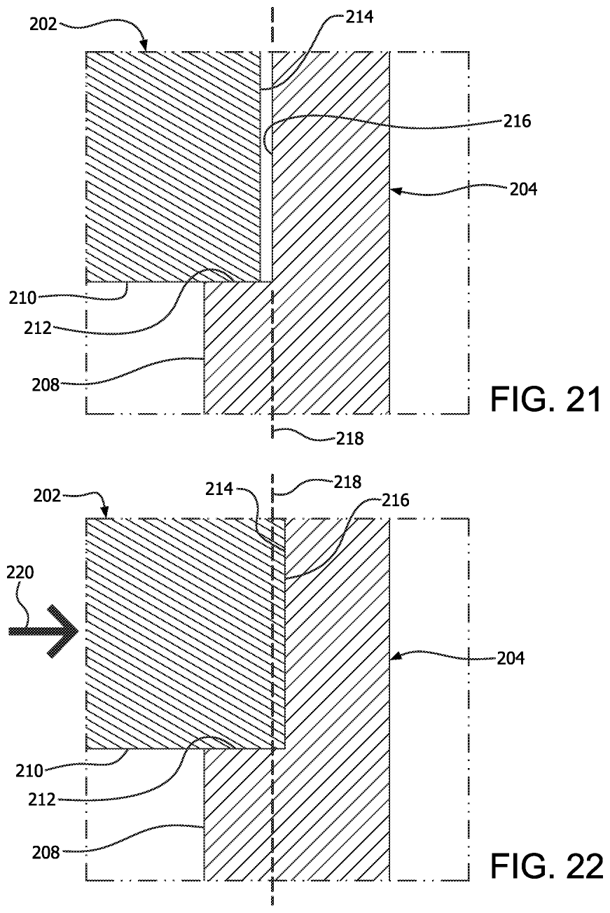

Other constructions are possible which can take advantage of the coefficient of thermal expansion. As shown in FIGS. 20-22 a capsule 200 can include a cap 202 and a housing 204 with an open interior 208. An inside surface 208 of the housing 204 communicates with a ledge 212 and a recessed inside wall surface 216 (FIG. 21). A bottom surface 210 of the cap 202 rests on the ledge 212 when the cap 202 is inserted into the housing 204.

In this embodiment, an outside surface 214 of the cap 202 is spaced from the recessed inside wall surface 216 of the housing 204. The cap 202 is shown extending above the housing 204, however, the cap 202 can also be flush with the top of the housing 204.

The cap 202 and the housing 204 are made of different materials with different coefficients of thermal expansion. In the embodiment shown in FIGS. 20-22 the cap 202 is made of a material with a higher coefficient of thermal expansion than is the housing 204. Accordingly, at increased temperatures the cap 202 will expand into the housing 204. In FIG. 21 the initial position of the recessed inside wall surface 216 of the housing 204 is indicated by dashed line 218. As shown in FIG. 22, as the temperature rises the cap material expands and creates a force indicated by arrow 220. The surface 214 of the cap 202 expands into contact with the surface 216 of the housing 204, such that the surface 216 now extends to a position laterally outwardly from the original position shown by the dashed line 218. Accordingly, an interference fit is created by the mismatched coefficients of thermal expansion as the temperature rises. The capsule 200 can be loaded in a low temperature environment such as a refrigerated chamber, and then when removed to room temperature will create a tight interference fit and seal.

It is also possible to utilize the coefficient of thermal expansion of the materials making the cap 202 and the housing 204 to make an interference fit even where the coefficients of thermal expansion are the same, in a form of shrink fit process. In such a process, only one of the cap or the housing is taken to a temperature different from that of the other of the cap or the housing. The cap and the housing are then assembled into a capsule, and both the cap and the housing are allowed to normalize to the same temperature, for example room temperature. At this temperature, the cap will engage the housing in an interference fit.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A capsule for maintaining containment of a substance within a predetermined volume, the capsule comprising:
a housing having a tubular shape and walls with an inside surface, wherein the housing has at least one open end; and
a cap configured to be assembled coaxially to the housing, the cap comprising a top and a plug configured to be inside the housing when the cap is assembled to the housing through the open end, wherein an outer surface of the plug is dimensioned to engage an adjacent inside surface of the housing in an interference fit of the cap with the housing.

2. The capsule of claim 1, wherein the plug comprises a first interference side portion and a first trough.

3. The capsule of claim 2, wherein the plug comprises a first interference protrusion, the first interference protrusion having an outside diameter greater than the outside diameter of the first interference side portion.

4. The capsule of claim 3, wherein the first trough is positioned between the first interference side portion and the first interference protrusion.

5. The capsule of claim 4, further comprising a second interference side portion and a second trough.

6. The capsule of claim 5, wherein the plug comprises a second interference protrusion, the second interference protrusion having an outside diameter greater than the outside diameter of the second interference side portion.

7. The capsule of claim 6, wherein the outside diameter of the second interference side portion is greater than the outside diameter of the first interference side portion, and the outside diameter of the second interference protrusion is greater than the outside diameter of the first interference protrusion.

8. The capsule of claim 7, wherein the housing comprises a plurality of inner interference surfaces comprising a plurality of inside diameters, and the inside diameters decrease from the open end.

9. The capsule of claim 8, wherein the plug comprises a relief, the relief having an outside diameter less than the outside diameter of the first trough and the second trough, the relief being positioned between the first interference side portion and the second interference side portion to permit flexing of the plug.

10. The capsule of claim 1, wherein the cap comprises a flange configured to abut the open end of the housing when the cap is assembled to the housing, the plug extending from the flange.

11. The capsule of claim 1, wherein at least a portion of the plug has a tubular shape with an open interior.

12. The capsule of claim 11, wherein the outer surface of the plug has a relief to enable flexing of the tubular portion of the plug.

13. The capsule of claim 1, wherein the plug is solid.

14. The capsule of claim 1, wherein the housing comprises one of a first material and a second material, and the cap comprises the other of the first material and the second material.

15. The capsule of claim 14, wherein the second material has a higher yield strength than the first material.

16. The capsule of claim 15, wherein the yield strength of the first material is at least 10% below the yield strength of the second material.

17. The capsule of claim 14, wherein the second material has a higher thermal coefficient of thermal expansion than the first material.

18. The capsule of claim 17, wherein the coefficient of thermal expansion of the first material is no more than 20% lower than the coefficient of thermal expansion of the second material.

19. The capsule of claim 14, wherein the coefficient of thermal expansion of the first material is no more than 5% higher or lower than the coefficient of thermal expansion of the second material.

20. The capsule of claim 14, wherein a friction coefficient at an interface between the first and second materials at a first temperature is equal to or greater than the coefficient of friction at a second temperature.

21. The capsule of claim 14, wherein the first material comprises austenitic-stainless steels, and the second material comprises nickel-based super alloys.

22. The capsule of claim 14, wherein the first material is annealed 304 stainless steel, and the second material is annealed Nitronic 60.

23. The capsule of claim 14, wherein the first material comprises Ta, and the second material comprises Ti.

24. The capsule of claim 1, wherein the capsule is a special form capsule.

25. The capsule of claim 1, wherein the housing comprises a groove disposed at its open end, the groove configured to vent, when the cap is assembled to the housing, gas trapped between the housing and the outer surface of the plug.

26. The capsule of claim 1, wherein the capsule maintains a vacuum seal.

27. The capsule of claim 1, wherein the plug has an end with an outer circumferential portion, and the housing comprises a ledge on the inner surface, and wherein the outer circumferential portion is configured to engage the ledge with the plug is assembled into the housing.

28. A method for sealing a capsule, comprising the steps of:
providing a housing having a tubular shape and walls with an inside surface, wherein the housing has at least one open end;
providing a cap configured to be assembled coaxially to the housing, the cap comprising a top and a plug configured to be inside the housing when the cap is assembled to the housing through the open end, wherein an outer surface of the plug is dimensioned to engage an adjacent inside surface of the housing in an interference fit of the cap with the housing; and,
assembling the cap to the housing by positioning the plug through the open end of the housing such that an outer surface of the plug engages an inside surface of the housing in an interference fit.

29. The method of claim 28, wherein the plug comprises a first interference side portion, a first trough, and a first interference protrusion, the first interference protrusion having an outside diameter greater than the outside diameter of the first interference side portion, the method comprising engaging the first interference side portion and the first interference protrusion to corresponding inside surfaces of the housing in interference fits, such that portions of the housing will be moved into the first trough.

30. The method of claim 29, wherein the plug further comprises a second interference side portion, a second trough, and a second interference protrusion, the second interference protrusion having an outside diameter greater than the outside diameter of the second interference side portion, and wherein the outside diameter of the second interference side portion is greater than the outside diameter of the first interference side portion, and the outside diameter of the second interference protrusion is greater than the outside diameter of the first interference protrusion, the method further comprising the step of engaging the second interference side portion and the second interference protrusion to corresponding inside surfaces of the housing in interference fits, such that portions of the housing will be moved into the second trough.

31. The method of claim 28, wherein the cap is engaged to the housing in a process in which one of the cap and the housing is taken to a temperature different to the other of the cap and the housing, the cap is assembled to the housing, and then the assembled cap and housing are taken to the same temperature, whereupon the cap will engage the housing in an interference fit.
